(19) United States
(12) Patent Application Publication
(10) Pub. No.: US 2026/0117556 A1
(43) Pub. Date: Apr. 30, 2026

(54) Door Handle Assembly

(71) Applicant: Illinois Tool Works Inc., Glenview, IL (US)

(72) Inventors: Penghui Yi, Shanghai (CN); Zsolt Wilke, Bad Mergentheim (DE); Fredrik Andersson, Vasteras (SE)

(21) Appl. No.: 19/367,332

(22) Filed: Oct. 23, 2025

(30) Foreign Application Priority Data
Oct. 24, 2024 (CN) 202411495757.2
Oct. 17, 2025 (CN) 202511492313.8

(51) Int. Cl. E05B 17/00; E05B 85/10

(52) U.S. Cl. CPC E05B 17/0016; E05B 85/103

(57) ABSTRACT

The present disclosure provides a door handle assembly for a vehicle. The door handle assembly includes a handle housing, a handle body and a heating device. The handle body is connected to the handle housing and movable relative to the handle housing between a retracted position and a deployed position. The heating device includes a base, a cover and a heating element. The heating device is connected to the handle housing via the base. The cover and the base collectively enclose to form a cavity. When the handle body is in the retracted position, the cavity surrounds the handle body. The heating element is disposed in the cavity and configured to generate heat. The thermal conductivity of the cover is greater than the thermal conductivity of the base, and the hardness of the cover is less than the hardness of the base. The cover of the heating device in the handle assembly of the present disclosure can function as a thermal conductive component, efficiently transferring heat from the heating element to the area to be heated, thereby ensuring high heating efficiency.

### RELATED APPLICATIONS

The present application claims the benefit of Chinese Patent Application Nos. 202411495757.2, filed Oct. 24, 2024, and 202511492313.8, filed Oct. 17, 2025, each titled “Door Handle Assembly,” the contents of which are hereby incorporated by reference.

### TECHNICAL FIELD

The present disclosure relates to a door handle assembly, and more particularly, to a hidden door handle assembly.

### BACKGROUND

A handle body of a vehicle hidden door handle can be retracted or deployed relative to the metal outer panel of the vehicle door. When the handle body is in the retracted position, its outer surface is flush with the surface of the metal outer panel of the vehicle door. When there is the need to open the door from the outside, the handle body is first deployed, allowing the operator to grip it, and then the door is opened by pulling the handle body. If the ambient temperature is low, the handle body is prone to freezing together with the metal outer panel of the vehicle door, which can prevent the handle body from deploying easily and make it difficult for the operator to open the door.

### SUMMARY

The present disclosure generally relates to a door handle assembly for a vehicle substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a door handle assembly according to an embodiment of the present disclosure installed on a vehicle door metal outer panel.

FIG. 1B is a perspective view of the door handle assembly shown in FIG. 1A.

FIG. 1C is an exploded view of the door handle assembly shown in FIG. 1A.

FIG. 2A is an exploded view of the heating device of the door handle assembly shown in FIG. 1C.

FIG. 2B is a perspective view of the heating device of the door handle assembly shown in FIG. 1C.

FIG. 2C is a partial cross-sectional view of the heating device of the door handle assembly shown in FIG. 1C.

FIG. 3 is a perspective view of the base of the heating device shown in FIG. 2A.

FIG. 4A is a perspective view of the cover of the heating device shown in FIG. 2A.

FIG. 4B is a perspective cross-sectional view of the cover shown in FIG. 2.

FIG. 5A is a cross-sectional view of the door handle assembly installed on the metal outer panel as shown in FIG. 1.

FIG. 5B is a partially enlarged view of FIG. 5A.

FIG. 6 is an illustrative view of a vehicle using the door handle assembly according to the present disclosure.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides a door handle assembly for a vehicle. The door handle assembly includes a handle housing, a handle body and a heating device. The handle body is connected to the handle housing and movable relative to the handle housing between a retracted position and a deployed position. The heating device includes a base, a cover and a heating element. The heating device is connected to the handle housing via the base. The cover and the base collectively enclose to form a cavity. When the handle body is in the retracted position, the cavity surrounds the handle body. The heating element is disposed in the cavity and configured to generate heat. The thermal conductivity of the cover is greater than the thermal conductivity of the base, and the hardness of the cover is less than the hardness of the base.

In some embodiments, when the door handle assembly is installed in place on the vehicle, the cover abuts against a flange, which faces the handle body, of a metal outer panel of a door of the vehicle.

In some embodiments, the thermal conductivity k of the cover has a value range of: k>1.5 W/m·K.

In some embodiments, the hardness m of the cover has a value range of: 60 Shore A≤m≤70 Shore A.

In some embodiments, the cover is made of a rubber material added with a thermally conductive filler.

In some embodiments, the door handle assembly further includes a heat storage element disposed in the cavity and configured to store heat generated by the heating element.

In some embodiments, the heat storage element is located on a side of the heating element facing away from the cover.

In some embodiments, the heating device is annular, the cover forms an inner periphery of the heating device facing the handle body, and the heating device abuts against the flange of the metal outer panel via the inner periphery.

In some embodiments, the base forms at least a portion of an outer periphery of the heating device away from the handle body.

In some embodiments, the base includes a base bottom plate and a base side plate, and the base side plate surrounds an outer edge of the base bottom plate away from the handle body. The cover includes a cover bottom plate and a cover side plate, and the cover side plate surrounds an inner edge of the cover bottom plate close to the handle body. The cover side plate abuts the base bottom plate, and the base side plate abuts the cover bottom plate, thereby enclosing to form the cavity. The cover side plate forms the inner periphery, and the base side plate forms a majority of the outer periphery.

In some embodiments, the cover side plate extends beyond the cover bottom plate in a direction away from the base bottom plate to form a lateral protrusion.

In some embodiments, the cover further includes a longitudinal protrusion disposed on a side of the cover side plate facing the handle body and located inward of the lateral protrusion.

In some embodiments, the base bottom plate is provided with a positioning protrusion, and the heat storage element and the heating element are respectively provided with a positioning slot to receive the positioning protrusion.

According to a second aspect of the present disclosure, the present disclosure provides a door handle assembly for a vehicle. The door handle assembly includes a handle housing, a handle body and a heating device. The handle body is connected to the handle housing and movable relative to the handle housing between a retracted position and a deployed position. The heating device includes a base, a cover and a heating element. The heating device is connected to the handle housing via the base. The cover and the base collectively enclose to form a cavity. When the handle body is in the retracted position, the cavity surrounds the handle body. The heating element is disposed in the cavity and configured to generate heat. When the door handle assembly is installed in place on the vehicle, the cover abuts against a flange, which faces the handle body, of a metal outer panel of a door of the vehicle.

In some embodiments, the thermal conductivity k of the cover has a value range of: k>1.5 W/m·K.

In some embodiments, the hardness m of the cover has a value range of: 60 Shore A≤m≤70 Shore A.

In some embodiments, the cover is made of a rubber material added with a thermally conductive filler.

In some embodiments, the door handle assembly further includes a heat storage element disposed in the cavity and configured to store heat generated by the heating element.

In some embodiments, the heating device is formed as an annular shape, the cover forms an inner periphery of the heating device facing the handle body, and the heating device abuts against the flange of the metal outer panel via the inner periphery.

According to a third aspect of the present disclosure, the present disclosure provides a vehicle including the aforementioned door handle assembly.

In the heating device of the handle assembly of the present disclosure, by setting the hardness of the cover to be relatively small and its thermal conductivity to be relatively large, the cover becomes easily deformable. This allows the cover to abut against the flange of the metal outer panel of the vehicle door without the need to avoid installation interference, which would otherwise prevent the cover from abutting against the flange. As a result, the cover of the heating device in the handle assembly of the present disclosure can function as a thermal conductive component, efficiently transferring heat from the heating element to the area to be heated, thereby ensuring high heating efficiency.

Various specific embodiments of the present disclosure will be described below with reference to the drawings which form part of this specification. It should be understood that although the terms indicating directions, such as “front”, “rear”, “upper”, “lower”, “left”, “right”, “top”, and “bottom” are used in the present disclosure to describe structural parts and elements in various examples of the present disclosure, these terms are used herein only for ease of illustration and are determined based on the exemplary orientations shown in the accompanying drawings. Since the arrangements in the embodiments disclosed in the present disclosure may be in various directions, these terms indicating directions are only illustrative and should not be considered as limitations.

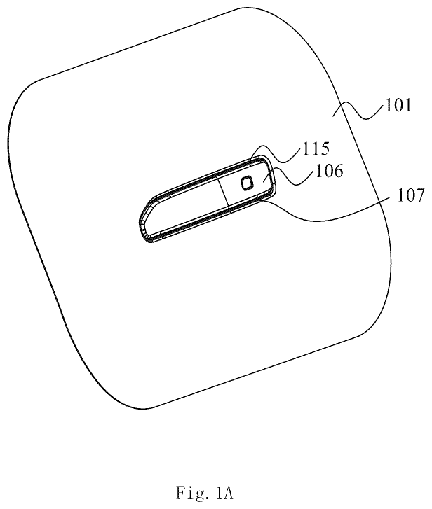

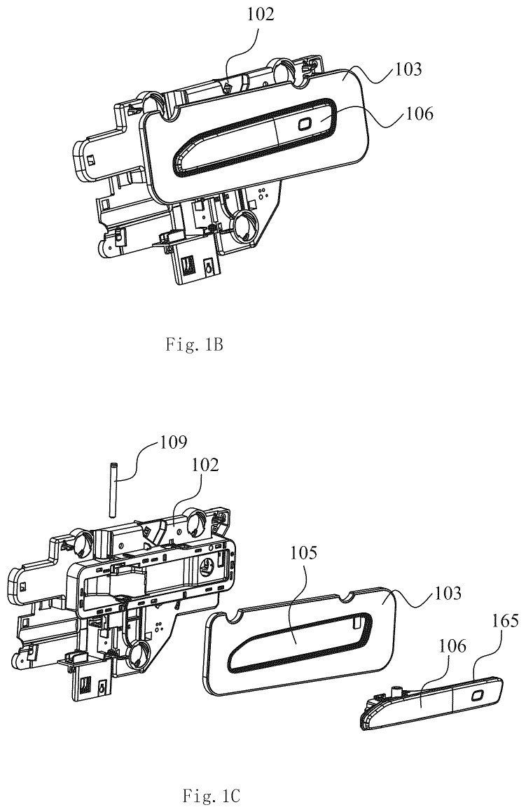

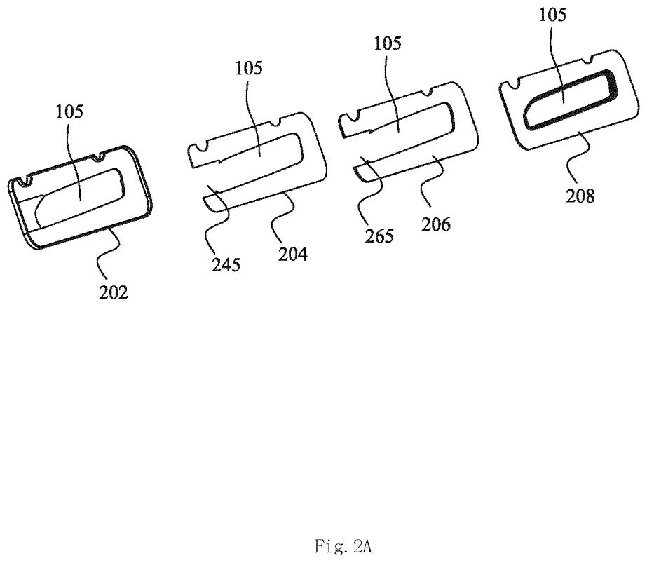

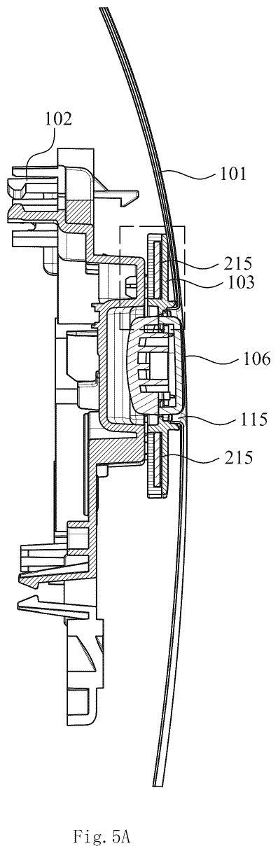

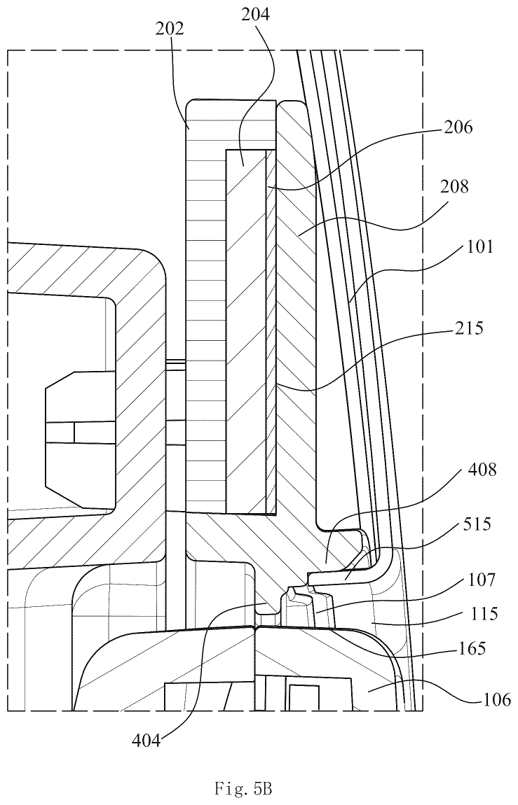

FIG. 1A is a perspective view of a door handle assembly according to an embodiment of the present disclosure installed on a metal outer panel 101 of a vehicle door. As shown in FIG. 1A, the metal outer panel 101 is substantially plate-shaped and has a flange 515 (see FIG. 5B). The flange 515 is bent inward relative to the metal outer panel 101 and defines an outer panel aperture 115.

The door handle assembly includes a handle body 106. The door handle assembly is, for example, a hidden door handle assembly, and the handle body 106 is movable relative to the metal outer panel 101 between a retracted position and a deployed position. When the handle body 106 is in the retracted position, it is located within the outer panel aperture 115, and an outer surface of the handle body 106 is flush with an outer surface of the metal outer panel 101. When the handle body 106 is in the deployed position, the outer surface of the handle body 106 extends outward relative to the outer surface of the metal outer panel 101, allowing an operator's hand to reach between the handle body 106 and the metal outer panel 101 to pull the handle body 106.

When the handle body 106 is located within the outer panel aperture 115, a gap 107 exists between an outer peripheral surface of the handle body 106 and the flange 515 of the metal outer panel 101, to allow the handle body 106 to move relative to the metal outer panel 101. When the ambient temperature is low, ice may be present in the gap 107, causing the handle body 106 and the metal outer panel 101 to freeze together. The ice may adhere to the outer peripheral surface of the handle body 106 and/or the flange 515 of the metal outer panel 101.

FIG. 1B is a perspective view of the door handle assembly, and FIG. 1C is an exploded view of the door handle assembly. As shown in FIGS. 1B and 1C, in addition to the handle body 106, the door handle assembly further includes a handle housing 102 and a heating device 103. The handle body 106 is rotatably connected to the handle housing 102 via a shaft 109 for movement between the retracted and deployed positions. The heating device 103 is also connected to the handle housing 102 to be supported by it. FIG. 1B shows the handle body 106 in the retracted position, where it is received by the heating device 103. For this purpose, the heating device 103 is provided with a handle aperture 105 extending through its thickness direction for accommodating the handle body 106. The heating device 103 is used to melt ice in the gap 107 between the outer peripheral surface 165 of the handle body 106 and the flange 515 of the metal outer panel 101 (see FIG. 5B).

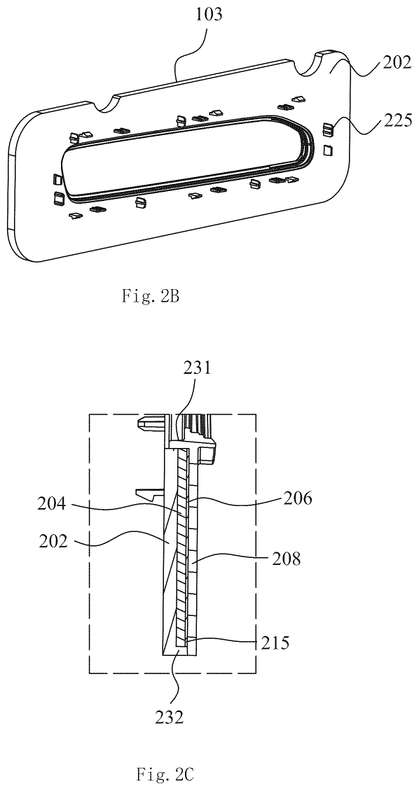

FIG. 2A is an exploded view of the heating device 103, FIG. 2B is a rear perspective view of the heating device 103, and FIG. 2C is a partial cross-sectional view of the heating device 103. As shown in FIGS. 2A to 2C, the heating device 103 includes a base 202, a heat storage element 204, a heating element 206, and a cover 208. The base 202 and the cover 208 enclose to form a cavity 215 (see FIG. 2C), and the heat storage element 204 and the heating element 206 are accommodated within the cavity 215. The heating element 206 is capable of generating heat. The heat storage element 204 is capable of storing heat generated by the heating element 206. The heating device 103 is connected to the handle housing 102 via the base 202. In the illustrated embodiment, the rear side of the base 202 is provided with several snap-fit portions 225 for engaging with complementary structures on the handle housing 102 to achieve connection between the base 202 and the handle housing 102. As shown in FIG. 2B, the heating device 103 is overall formed in an annular shape. As shown in FIG. 2C, the cover 208 forms an inner periphery 231 of the annular heating device 103, and the heating device 103 abuts the flange 515 of the metal outer panel 102 (see FIG. 5B) via this inner periphery 231. The base 202 forms a majority of an outer periphery 232 of the annular heating device 103. In other embodiments, the base 202 may form the entire outer periphery 232 of the heating device 103. In some embodiments, the base 202 and the cover 208 of the heating device 103 are fixedly connected to each other, for example, by an adhesive. In other embodiments, the base 202 and the cover 208 of the heating device 103 are clamped between the vehicle door metal outer panel 102 and the handle housing 102, requiring no adhesive connection.

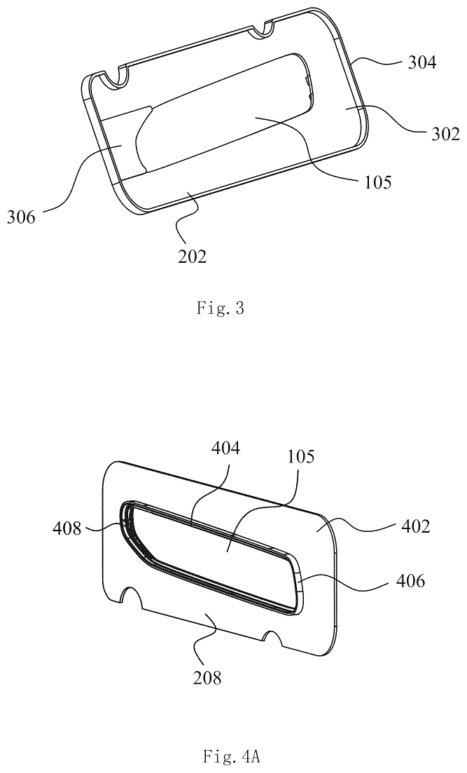

FIG. 3 is a perspective view of the base 202. As shown in FIG. 3, the base 202 includes a base bottom plate 302 and a base side plate 304. The base bottom plate 302 is substantially a flat plate, and the handle aperture 105 passes through it. The base side plate 304 surrounds an outer edge of the base bottom plate 302 and extends substantially in the thickness direction. The thermal conductivity K of the base 202 falls within the range of K<0.3 W/m·K. In the present disclosure, as an example, the base 202 is made of a rigid plastic material.

Still referring to FIG. 3, the base 202 further includes a positioning protrusion 306. The positioning protrusion 306 is disposed on the inner side of the base bottom plate 302 and located on one side of the handle aperture 105 along its length direction. A portion of the positioning protrusion 306 defines the handle aperture 105. In the thickness direction, the thickness of the positioning protrusion 306 is substantially the same as the thickness of the base side plate 304.

As shown in FIG. 2A, the heat storage element 204 is substantially a flat, thin plate and has a U-shape. In the thickness direction, an inner side of the heat storage element 204 abuts the base bottom plate 302, and an outer side of the heat storage element 204 abuts the heating element 206. The notch of the U shape of the heat storage element 204 forms a positioning slot 245 for cooperating with the positioning protrusion 306 (FIG. 3), facilitating the positioning and installation of the heat storage element 204 relative to the base 202. In the present disclosure, as one embodiment, the heat storage element 204 is made of a plastic with a relatively high specific heat capacity. For example, the specific heat capacity c of the heat storage element 204 falls within the range: c≥4.2×10³ J/(kg·° C.).

Still referring to FIG. 2A, the heating element 206 is substantially a flat, thin plate and has a U-shape. In the thickness direction, an inner side of the heating element 206 abuts the heat storage element 204, and an outer side of the heating element 206 abuts the cover 208. The notch of the U shape of the heating element 206 forms a positioning slot 265 for cooperating with the positioning protrusion 306 (FIG. 3), facilitating the positioning and installation of the heating element 206 relative to the base 202. In the present disclosure, as one embodiment, the heating element 206 is a PTC heating sheet, which generates heat when energized. In other embodiments, the heating element 206 can be other types of heating elements that generate heat upon energization. In other embodiments, the heating element may also be L-shaped, having a bent end portion located near the handle aperture.

Although in the embodiment of the present disclosure the heat storage element 204 and the heating element 206 are substantially U-shaped, in other embodiments, they may not be U-shaped, as long as they are provided with positioning slots adapted to engage with the positioning protrusion 306.

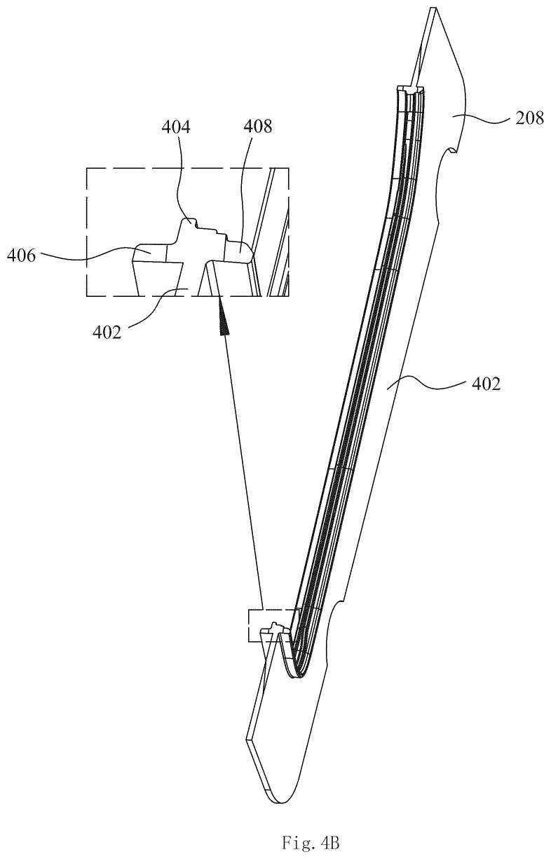

FIG. 4A is a perspective view of the cover 208 shown in FIG. 2A, and FIG. 4B is a perspective cross-sectional view of the cover 208. As shown in FIGS. 4A and 4B, the cover 208 includes a cover bottom plate 402 and a cover side plate 406. The cover bottom plate 402 is substantially a thin plate, and the handle aperture 105 passes through it. The cover side plate 406 surrounds an inner edge of the cover bottom plate 402 and extends substantially in the thickness direction. When the heating device is installed in place, the positioning protrusion on the base passes through the heat storage element and the heating element and abuts the cover bottom plate 402. The cover side plate 406 is for abutting the base bottom plate 302 (see FIG. 3), and the cover bottom plate 402 is for abutting the base side plate 304 (see FIG. 3), so that the cover 208 and the base 202 together enclose and form the cavity 215 (see FIG. 2C).

As shown in FIG. 4B, the cover side plate 406 extends beyond the cover bottom plate 402 in a direction away from the base bottom plate (i.e., outward) to form a lateral protrusion 408, for increasing the contact area between the cover 208 and the flange 515 of the metal outer panel 101 (FIG. 5B). The cover 208 further includes a longitudinal protrusion 404 provided on the side of the cover side plate 406 facing the handle body (i.e., the side facing away from the cover bottom plate 402) and located inward of the lateral protrusion 408.

In the present disclosure, as one embodiment, the thermal conductivity k of the cover 208 falls within the range: k>1.5 W/m·K, and the hardness m of the cover 208 falls within the range: 60 Shore A≤m≤70 Shore A. As one embodiment, the thermal conductivity of the cover 208 is greater than 1.5 W/m. K, and its hardness is 65 Shore A. As one embodiment, the cover 208 is made of a rubber material added with a thermally conductive filler, such as silicone rubber added with aluminum oxide. Thus, the hardness of the cover 208 in the present disclosure is less than the hardness of the base 202, but the thermal conductivity of the cover 208 is greater than the thermal conductivity of the base 202. This makes the cover 208 relatively easy to deform and facilitates heat conduction.

FIG. 5A is a cross-sectional view of the door handle assembly installed on the metal outer panel 101, and FIG. 5B is a partial enlarged view of the area within the dashed box in FIG. 5A. As shown in FIG. 5A, when the door handle assembly is installed in place on the metal outer panel 101, the handle body 106 is partially located within the outer panel aperture 115 of the metal outer panel 101 of the vehicle door. The cavity 215 of the heating device 103 surrounds the handle body 106. The handle housing 102 and the heating device 103 are located on the inner side of the metal outer panel 101. The heating device 103 is located between the handle housing 102 and the metal outer panel 101 and is adjacent to the metal outer panel 101.

As shown in FIG. 5B, a gap 107 exists between the outer peripheral surface 165 of the handle body 106 and the flange 515 of the metal outer panel 101. The gap 107, as well as the flange 515 of the metal outer panel 101 and the outer peripheral surface 165 of the handle body 106 adjacent to the gap 107, constitute the area to be heated. The cover 208 of the heating device 103 abuts the flange 515 of the metal outer panel 101 via the lateral protrusion 408. Thus, when the heating element 206 generates heat, the heat can be directly transferred through the cover 208, which has a higher thermal conductivity, to the flange 515 of the metal outer panel 101, and further transferred through the flange 515 to other areas to be heated, thereby melting ice adhering to the flange 515 of the metal outer panel 101 and/or the outer peripheral surface 165 of the handle body 106. The base 202, with its lower thermal conductivity, is less able to transfer heat compared to the cover 208.

Furthermore, the longitudinal protrusion 404 of the cover 208 extends into the gap 107 between the outer peripheral surface 165 of the handle body 106 and the flange 515 of the metal outer panel 101, which also facilitates heat transfer to the area to be heated.

Additionally, the heat storage element 204 is disposed adjacent to the heating element 206. Although heat from the heating element 206 can be transferred to areas of the metal outer panel 101 that are not desired to be heated, the provision of the heat storage element 204, which can absorb and store the heat generated by the heating element 206, can significantly reduce the heat dissipation rate from those undesired areas of the metal outer panel 101.

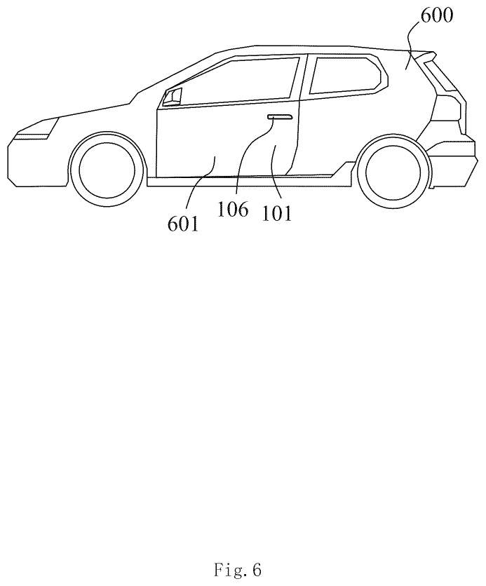

FIG. 6 is an illustrative view of a vehicle using the door handle assembly according to the present disclosure. As shown in FIG. 6, a door 601 of the vehicle 600 has the metal outer panel 101, and the door handle assembly of the present disclosure is arranged on the metal outer panel 101 of the door 601. The outer surface of the handle body 106 can be flush with the outer surface of the metal outer panel 101.

In the heating device of the handle assembly of the present disclosure, by setting the hardness of the cover to be relatively small and its thermal conductivity to be relatively large, the cover becomes easily deformable. This allows the cover to abut against the flange of the metal outer panel of the vehicle door without the need to avoid installation interference, which would otherwise prevent the cover from abutting against the flange. As a result, the cover of the heating device in the handle assembly of the present disclosure can function as a thermal conductive component, efficiently transferring heat from the heating element to the area to be heated, thereby ensuring high heating efficiency.

Furthermore, by providing the heat storage element, the present disclosure effectively stores the heat generated by the heating element, thereby preventing heat loss.

While the present device and/or system have been described with reference to certain examples, it will be understood by those skilled in the art that various changes may be made and equivalents may be substituted without departing from the scope of the present device and/or system. In addition, many modifications may be made to adapt a particular situation or material to the teachings of the present disclosure without departing from its scope. For example, components of disclosed examples may be combined, divided, re-arranged, and/or otherwise modified. Therefore, the present device and/or system are not limited to the particular examples disclosed. Instead, the present device and/or system will include all examples falling within the scope of the appended claims, both literally and under the doctrine of equivalents.

### MAIN REFERENCE SIGNS

Metal Outer Panel 101
Handle Housing 102
Heating Device 103
Outer Panel Aperture 115
Handle Aperture 105
Handle Body 106
Gap 107
Shaft 109
Base 202
Heat Storage Element 204
Heating Element 206
Cover 208
Cavity 215
Snap-Fit Portion 225
Positioning Slot 245, 265
Base Bottom Plate 302
Inner Periphery 231
Outer Periphery 232
Base Side Plate 304
Positioning Protrusion 306
Cover Bottom Plate 402
Longitudinal Protrusion 404
Cover Side Plate 406
Lateral Protrusion 408
Flange 515
Vehicle 600
Door 601

What is claimed is:

1. A door handle assembly for a vehicle, comprising:
a handle housing;
a handle body connected to the handle housing and movable relative to the handle housing between a retracted position and a deployed position; and
a heating device, comprising:
a base, the heating device being connected to the handle housing via the base;
a cover, the cover and the base collectively enclosing to form a cavity, wherein when the handle body is in the retracted position, the cavity surrounds the handle body; and
a heating element disposed in the cavity and configured to generate heat, wherein the thermal conductivity of the cover is greater than the thermal conductivity of the base, and the hardness of the cover is less than the hardness of the base.

2. The door handle assembly of claim 1, wherein when the door handle assembly is installed in place on the vehicle, the cover abuts against a flange, which faces the handle body, of a metal outer panel of a door of the vehicle.

3. The door handle assembly of claim 1, wherein the thermal conductivity k of the cover has a value range of: k>1.5 W/m·K.

4. The door handle assembly of claim 1, wherein the hardness m of the cover has a value range of: 60 Shore A≤m≤70 Shore A.

5. The door handle assembly of claim 1, wherein the cover is made of a rubber material added with a thermally conductive filler.

6. The door handle assembly of claim 1, further comprising a heat storage element disposed in the cavity and configured to store heat generated by the heating element.

7. The door handle assembly of claim 6, wherein the heat storage element is located on a side of the heating element facing away from the cover.

8. The door handle assembly of claim 1, wherein the heating device is annular, the cover forms an inner periphery of the heating device facing the handle body, and the heating device abuts against the flange of the metal outer panel via the inner periphery.

9. The door handle assembly of claim 8, wherein the base forms at least a portion of an outer periphery of the heating device away from the handle body.

10. The door handle assembly of claim 9, wherein:
the base comprises a base bottom plate and a base side plate, the base side plate surrounding an outer edge of the base bottom plate away from the handle body;
wherein the cover comprises a cover bottom plate and a cover side plate, the cover side plate surrounding an inner edge of the cover bottom plate close to the handle body; and
wherein the cover side plate abuts the base bottom plate, and the base side plate abuts the cover bottom plate, thereby enclosing to form the cavity, the cover side plate forming the inner periphery, and the base side plate forming a majority of the outer periphery.

11. The door handle assembly of claim 10, wherein the cover side plate extends beyond the cover bottom plate in a direction away from the base bottom plate to form a lateral protrusion.

12. The door handle assembly of claim 10, wherein the cover further comprises a longitudinal protrusion disposed on a side of the cover side plate facing the handle body and located inward of the lateral protrusion.

13. The door handle assembly of claim 10, wherein the base bottom plate is provided with a positioning protrusion, and the heat storage element and the heating element are respectively provided with a positioning slot to receive the positioning protrusion.

14. A door handle assembly for a vehicle, comprising:
a handle housing;
a handle body connected to the handle housing and movable relative to the handle housing between a retracted position and a deployed position; and
a heating device, comprising:
a base, the heating device being connected to the handle housing via the base;
a cover, the cover and the base collectively enclosing to form a cavity, wherein when the handle body is in the retracted position, the cavity surrounds the handle body; and
a heating element disposed in the cavity and configured to generate heat,
wherein when the door handle assembly is installed in place on the vehicle, the cover abuts against a flange, which faces the handle body, of a metal outer panel of a door of the vehicle.

15. The door handle assembly of claim 14, wherein the thermal conductivity k of the cover has a value range of: k>1.5 W/m·K.

16. The door handle assembly of claim 14, wherein the hardness m of the cover has a value range of: 60 Shore A≤m≤70 Shore A.

17. The door handle assembly of claim 14, wherein the cover is made of a rubber material added with a thermally conductive filler.

18. The door handle assembly of claim 14, further comprising a heat storage element disposed in the cavity and configured to store heat generated by the heating element.

19. The door handle assembly of claim 14, wherein the heating device is formed as an annular shape, the cover forms an inner periphery of the heating device facing the handle body, and the heating device abuts against the flange of the metal outer panel via the inner periphery.

20. A vehicle comprising the door handle assembly of claim 1.
